(19) United States
(12) Patent Application Publication
(10) Pub. No.: US 2010/0199187 A1
(43) Pub. Date: Aug. 5, 2010

(54) INSTANT DATA SHARING SYSTEM AND MACHINE READABLE MEDIUM THEREOF

(75) Inventors: Chih-Hsiang Lin, Taipei Hsien (TW); Chi-Cheng Chiang, Taipei Hsien (TW); Chien-Tang Tseng, Taipei Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ACER INCORPORATED, Taipei Hsien (TW)

(21) Appl. No.: 12/612,876

(22) Filed: Nov. 5, 2009

(30) Foreign Application Priority Data
Feb. 3, 2009 (TW) 98103376

(51) Int. Cl. G06F 3/048; G06F 15/16

(52) U.S. Cl. 715/733; 715/781; 709/204

(57) ABSTRACT

An instant data sharing system is provided. The system comprises a user interface (UI) module, an instant communication module and a data sharing module. The UI module comprises a communication window and a presentation window and is used for operating the data sharing system by a user. The instant communication module establishes an instant communication with at least one remote host via a network, wherein the user performs the instant communication with the remote host via the communication window. The data sharing module is used for selecting a shared data, displaying the shared data on the presentation window and transmitting the shared data to the remote host. The data sharing module selects an encoding operation module to encode the shared data according to a type of the shared data, and transmits the encoded shared data to the remote host through a transmission module.

### CROSS REFERENCE TO RELATED APPILCATIONS

This Application claims priority of Taiwan Patent Application No. 098103376, filed on Feb. 3, 2009, the entirety of which is incorporated by reference herein.

### BACKGROUND OF THE INVENTION

1. Field of the Invention

The invention relates to a data sharing method and sharing system thereof, and more particularly, to an instant communication based data sharing method and system for providing instant picture sharing and data sharing with specific content across various operating system platforms.

2. Description of the Related Art

Recently, as network applications become more and more popular, communication using an instant messenger (IM) such as MSN messenger of Microsoft or Yahoo! are also becoming more popular. These instant messaging services separately utilize different IM protocols to allow two or more users to transmit text messages, files, audio and video data instantly via a network. In addition to providing one-by-one message transmission, for users who use the same IM software, some network sharing links such as chartroom for multi-users may be available.

In addition to text messaging, IM may further provide a video conference function such that multi-users may transmit video and/or audio data by a webcam and a microphone device respectively to conduct a meeting and transmit files to each other through the established video conference.

Generally, picture sharing with the IM service is implemented by sending a picture to be shared directly from the sharing side to the receiving side. However, as the picture file is always large sized, the receiving side has to wait for a long time to successfully receive the whole picture from the sharing side. Additionally, no drawing function is currently provided for picture sharing with the IM service.

Although conventional video conference methods such as the NetMeeting provides window sharing functions for programs that are opened, a cover portion for a window to be shared can not be displayed onto the receiving side if the window is covered by other windows. Some IM services provide a remote control function for controlling a desktop of a remote host by the remote host. This kind of remote control function, however, may only control and display the desktop, and can not assign which content to be shared for the remote host.

Currently, no convenient document file sharing mechanism is provided to provide users with instant and fast document sharing.

### BRIEF SUMMARY OF THE INVENTION

A data sharing method and sharing system thereof are disclosed for providing instant data sharing of picture data and data with specific data content at the same time.

An embodiment of an instant data sharing system is provided. The system comprises a user interface (UI) module, an instant communication module and a data sharing module. The UI module comprises a communication window and a presentation window and is used for operating the data sharing system by a user. The instant communication module establishes an instant communication with at least one remote host via a network, wherein the user performs the instant communication with the remote host via the communication window. The data sharing module is used for selecting a shared data, displaying the shared data on the presentation window and transmitting the shared data to the remote host. The data sharing module selects an encoding operation module to encode the shared data according to a type of the shared data, and transmits the encoded shared data to the remote host through a transmission module.

Another embodiment of an instant data sharing system for establishing an instant communication between first and second hosts is further provided, wherein the first host further comprises a communication module and a drawing module. The communication module comprises a user interface (UI) module, an instant communication module and a data sharing module. The user interface (UI) module is used for operating the data sharing system by a user, wherein the UI module comprises a communication window and a presentation window. The instant communication module establishes the instant communication with the second host and displays the instant communication content on the communication window. The data sharing module selects a shared data and performs an instant data sharing operation to the second host via the presentation window. The drawing module has a mouse event handling module for detecting and recording a moving track data of a mouse point on the presentation window for the first or the second host, wherein the drawing module superimposes a drawing window that is generated for representing the moving track data according to the moving track data on the presentation window.

Data sharing methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention can be more fully understood by reading the subsequent detailed description and examples with reference to the accompanying drawings, wherein:

FIG. 1A shows a block diagram of an embodiment of a data sharing system according to the invention;

FIG. 1B shows a schematic diagram of an embodiment of an interactive interface according to the invention;

FIG. 2A shows a schematic diagram of an embodiment of a presentation window according to the invention;

FIG. 2B shows a schematic diagram of an embodiment of a drawing window generated by a drawing module according to the invention;

FIG. 2C shows a schematic diagram of another embodiment of a drawing window generated by the drawing module according to the invention;

FIGS. 3A and 3B show schematic diagram of functional blocks corresponding to a document sharing operation according to the invention;

FIG. 4 is a flowchart showing an embodiment of a data sharing method for performing a document sharing operation in a shared host according to the invention;

FIGS. 5A and 5B show schematic diagram of functional blocks corresponding to a window sharing operation according to the invention;

FIG. 6 shows a schematic diagram of an embodiment of a selection window according to the invention;

FIG. 7 is a flowchart showing an embodiment of a data sharing method for performing a window sharing operation in a shared host according to the invention; and

FIGS. 8A and 8B show schematic diagram of functional blocks corresponding to a picture sharing operation according to the invention.

### DETAILED DESCRIPTION OF THE INVENTION

The following description is of the best-contemplated mode of carrying out of the invention. This description is made for the purpose of illustrating the general principles of the invention and should not be taken in a limiting sense. The scope of the invention is best determined by reference to the appended claims.

Embodiments of the invention provide a data sharing system and related data sharing method for providing various data such as documents, window and picture sharing functions when a sharing host (first host) is performing an instant communication such as a video conference with a remote host to increase convenience of instant communication.

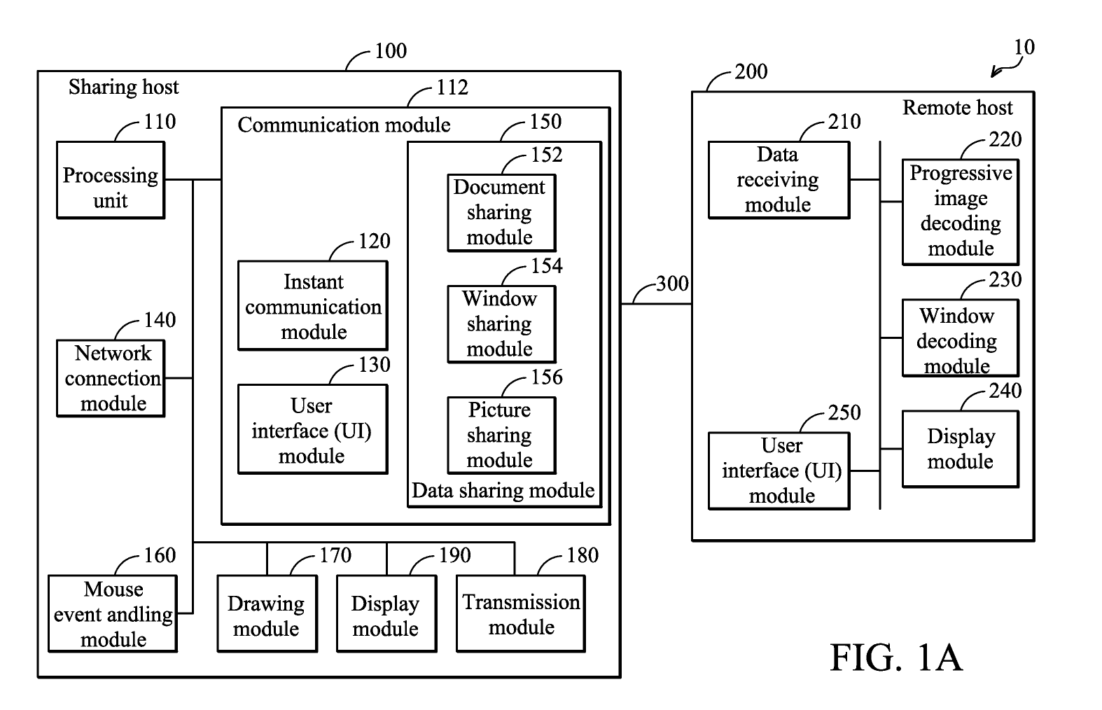

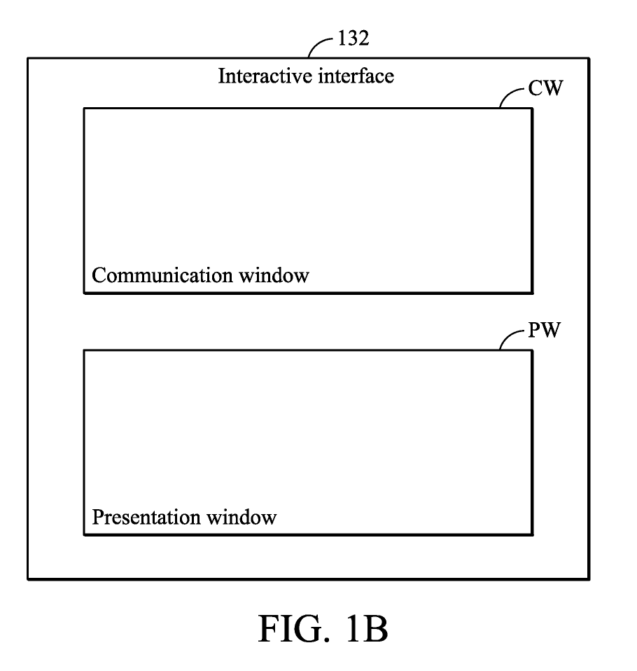

FIG. 1A shows a block diagram of an embodiment of a data sharing system 10 according to the invention. As shown in FIG. 1A, the data sharing system 10 comprises a sharing host 100 (i.e. the first host) and a remote host 200 (i.e. the second host) in which the sharing host 100 is capable of performing an instant communication such as sending instant messages with the remote host 200 via a network 300. For example, the instant communication may a textural communication, a video conference communication, an audio communication and/or a combination thereof, but it is not limited thereto. When performing the instant communication (e.g. a video conference), the remote host 200 may obtain a shared data content from the sharing host 100 through the network 300. In one embodiment, type of the shared data may be a shared document, a shared window and/or a shared picture, but it is not limited thereto.

The sharing host 100 at least comprises a processing unit 110, a communication module 120, a network connection module 140, a mouse event handling module 160, a drawing module 170, a transmission module 180 and a display module 190, wherein the communication module 112 further comprises an instant communication module 120, a user interface (UI) module 130 and a data sharing module 150.

The network connection module 140 is used for establishing connections between users on the network, such as connecting to the remote host 200 to perform an instant communication via the network 300.

The communication module 120 is used for establishing an instant communication such as document communication, video conference and audio communication between the sharing host 100 and the remote host 200.

The user interface (UI) module 130 provides an interactive interface 132 for interacting between a user and the data sharing system. FIG. 1B shows a schematic diagram of an embodiment of an interactive interface according to the invention. As shown in FIG. 1B, the interactive interface 132 includes a communication window CW and a presentation window PW and is capable of simultaneously presenting video screens of the sharing host 100 and the remote host 200 on the communication window CW and displaying the screen of the shared picture, document and window on the presentation window PW when performing the instant communication.

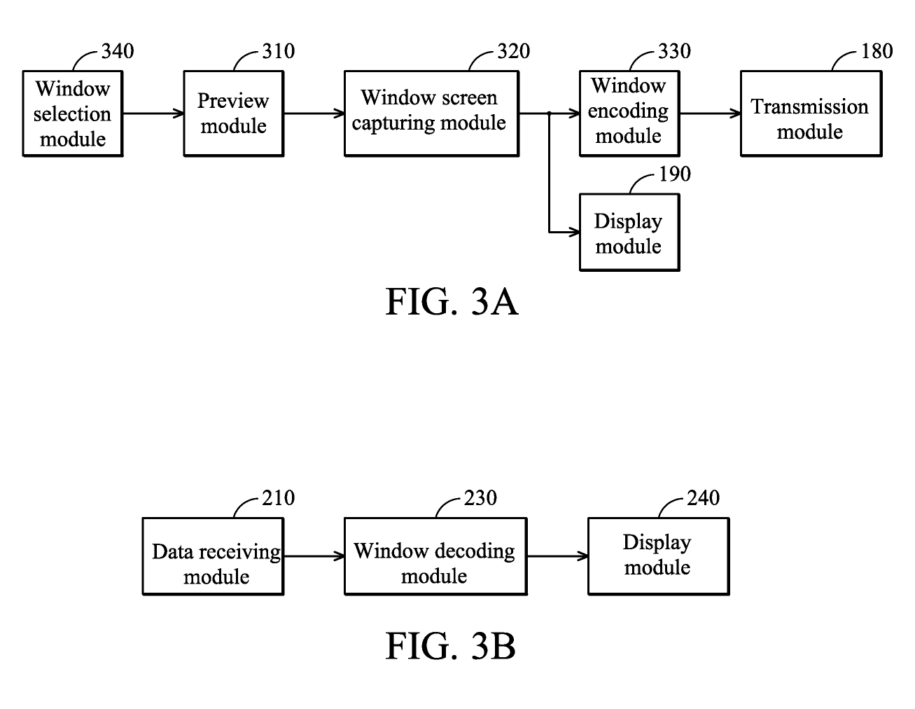

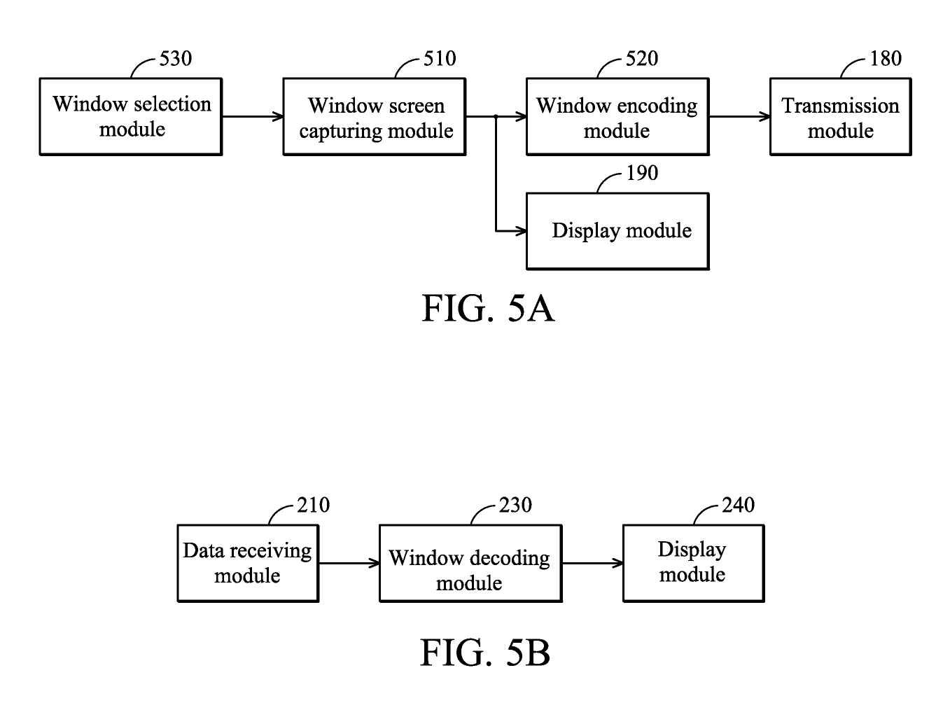

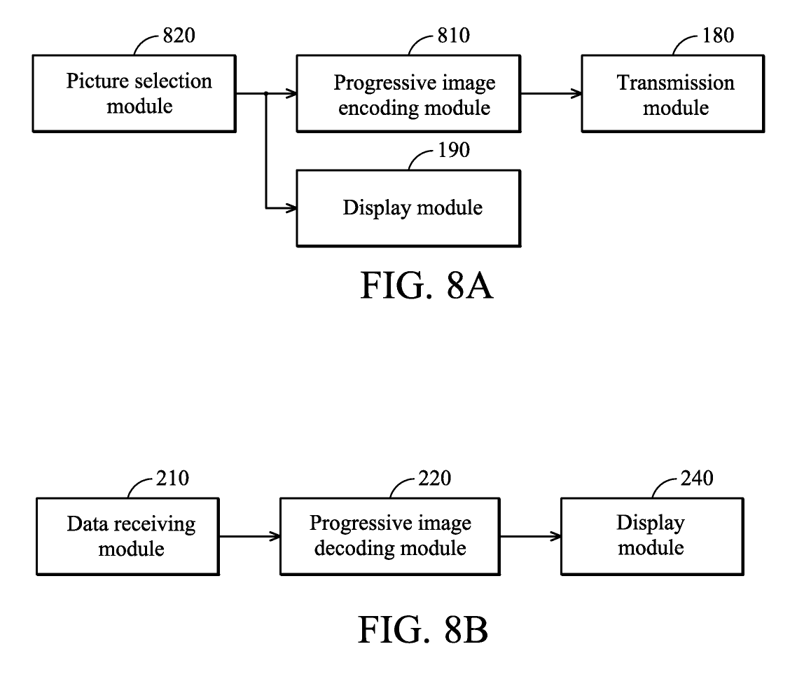

The data sharing module 150 further comprises a selection module (such as a window selection module 340 shown in FIG. 3A and a window selection module 530 shown in FIG. 5A) and/or a picture selection module (such as a picture selection module 820 shown in FIG. 8A), wherein the window selection module is used for the local user to select a shared document or a screen of an opened window when a document sharing or a window sharing operation is performed and the picture selection module is used for the user to select a shared picture file when a picture sharing operation is performed.

The processing unit 110 is coupled to the network connection module 140 and the data sharing module 150 for managing communication between every module and operation of the system. For example, when detecting that an instant communication (e.g. a video conference) has been established by the communication module 120 and a document sharing operation is required, the processing unit 110 receives a document sharing selection and directs the data sharing module 150 to obtain an opened content corresponding to the selected shared document and utilizes the display module 190 to display the opened content on the PW of the user interface (UI) module 130 and transmits a screen picture corresponding to the opened content to the remote host 200 for performing a document sharing operation, wherein the selected shared document may be divided into one kind of previewable document that supports a preview format and another kind of non-previewable document that does not support a preview format. The previewable document that supports a preview format represents a document, wherein the document file format supports a preview function, i.e. the user may view a preview content of the document from a preview window without using any program to open it.

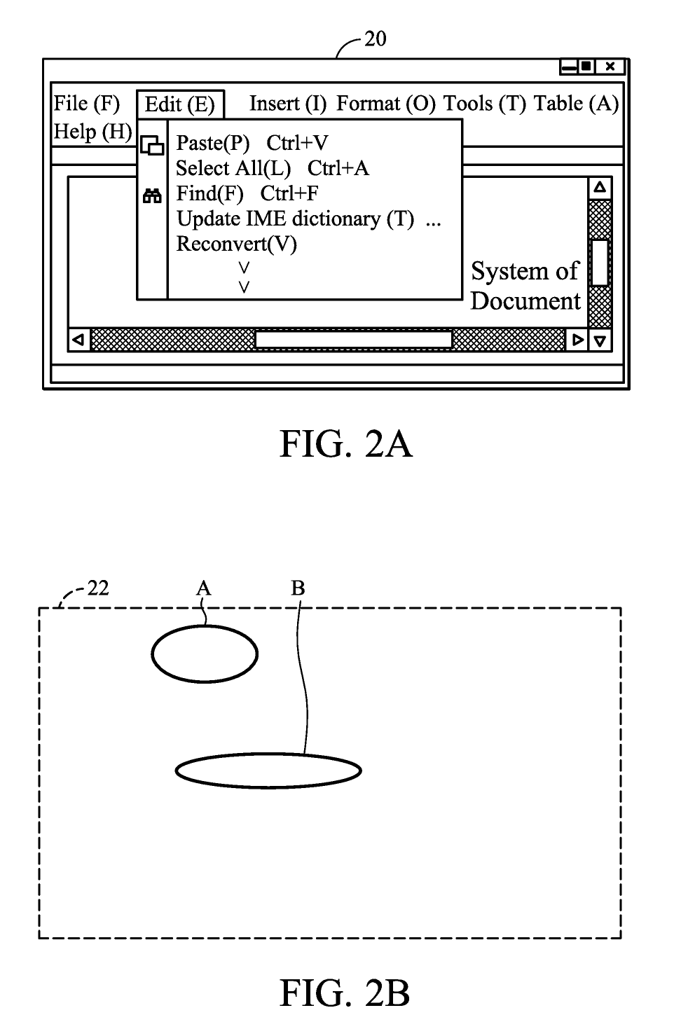

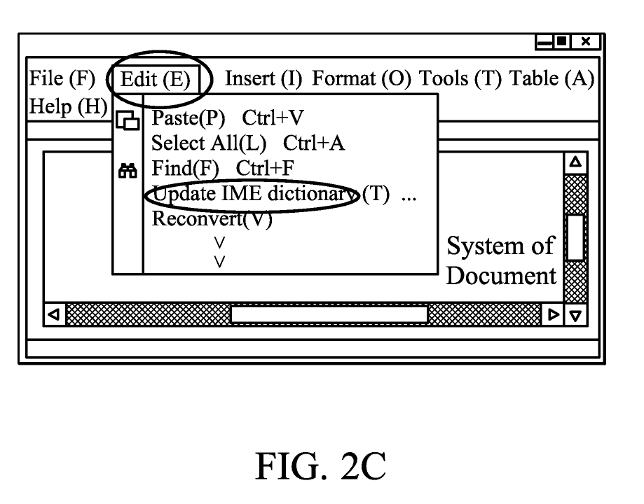

The mouse event handling module 160 is used for recording mouse related information such as information regarding moving and clicking of the mouse and detecting and recording a moving track data of a mouse point on the presentation window. For example, the mouse event handling module 160 may detect and record moving track data of mouse points on the presentation window for the sharing host 100 or the remote host 200 when the data sharing such as a document sharing operation is being performed. The drawing module 170 is coupled to the mouse event handling module 160 for generating a drawing window according to the mouse track recorded by the mouse event handling module 160 and superimposes the drawing window and the shared screen on the presentation window. It is to be noted that, in one embodiment, the mouse event handling module 160 may be included in the drawing module 170. Please refer to FIGS. 2A and 2C.

FIG. 2A shows a schematic diagram of an embodiment of a presentation window according to the invention. As shown in FIG. 2a, a presentation window 20 for presenting the shared picture, window or document by the user interface (UI) module 130 of the sharing host 100 (local) or the remote host 200 (remote) is illustrated.

FIG. 2B shows a schematic diagram of an embodiment of a drawing window 22 generated by the drawing module 170 according to the invention. Note that the initial background color of the drawing window 22 is configured as a transparent color. The drawing module 170 draws mouse tracks of the sharing host 100 and/or the remote host 200 recorded by the mouse event handling module 160 according to the drawing color and lines user desired on the drawing window 22, wherein information for the remote host 200 such as the mouse track of the remote host 200 may be obtained by the network connection module 140.

Note that the drawing functions provided by the mouse event handling module 160 and the drawing module 170 may be utilized in various data sharing operations such as document, window and picture sharing.

For example, referring to FIG. 2B, line A represents a mouse moving and a click track on the presentation window 20 of the sharing host 100 performed by a user in the sharing host 100 while line B represents a mouse moving and a click track on the presentation window 20 of the remote host 200 performed by a user in the remote host 200. Thus, the drawing window 22 and the original shared screen 20 are superimposed on the presentation window as the final screen represented to the user, as shown in FIG. 2C.

In this embodiment, user may select to clear the drawing line on the drawing window by using the buttons of the user interface, such as configuring the color of the drawing window back to a transparent color to achieve a goal for clear the drawing line on the drawing window. The user may select to hide or display the drawing line by using the buttons of the user interface, such as hiding or displaying the drawing window.

The display module 190 displays the shared content selected by the sharing host 100 on the presentation window (e.g. the window 20 in the FIG. 2A). The transmission module 180 transmits screen data corresponding to the preview content of a shared document.

The remote host 200 comprises multiple modules corresponding to the sharing host 100, which at least comprises a data receiving module 210, a progressive image decoding module 220, a window decoding module 230, a display module 240 and a user interface (UI) module 250. The data receiving module 210 receives shared data from the transmission module 180 of the sharing host 100, such as data packets corresponding to the progressively compressed picture or video stream corresponding to the selection window. The progressive image decoding module 220 and the window decoding module 230 are separately coupled to the data receiving module 210, and when the received data is a data packet of the progressively compressed picture, the progressive image decoding module 220 sequentially decodes each of the data packets corresponding to the progressively compressed picture so as to obtain a decode image that is an image which is firstly blurred and then becomes more and more clearly. When the received data is a video stream corresponding to the window, the window decoding module 230 decodes the video stream to obtain a decoded screen corresponding to the received window data. The decoded result decoded by the progressive image decoding module 220 and the window decoding module 230 are sent to the display module 240. The display module 240 is coupled to the progressive image decoding module 220 and 230 and receives the decoded result and utilizes the user interface (UI) module 250 to display the decoded image and/or the decoded screen on the presentation window of the remote host 200. Note that operation of the user interface (UI) module 250 is the same as that of the user interface (UI) module 130 and thus detail is omitted.

As aforementioned, in some embodiments of the invention, the data sharing module 150 may further comprise a document sharing module 152, a window sharing module 154 and a picture sharing module 156 for performing a document sharing operation, a window sharing operation and a picture sharing operation respectively. The operations are descried in detail in the following.

Note that, for illustration, only units or modules of the FIG. 1A that are used for the data sharing operations are illustrated in the following embodiment, but the invention is not limited thereto.

When the type of the shared data is a shared document, the data sharing module may be a document sharing unit, wherein the document sharing unit 152 may comprise a preview module 310, a window screen capturing module 320, a window encoding module 330 and a window selection module 340. When the shared document selected by the window selection module 340 is a previewable document, the preview module 310 generates a preview window for displaying a preview content of the shared document and the window screen capturing module 320 captures the screen of the preview window. When the shared document selected by the window selection module 340 is not a previewable document, the window screen capturing module 320 captures the screen of the opened window of the shared document that is selected by the window selection module 340. The data sharing module 150 compresses and encodes the screen of the shared window captured by the window screen capturing module 320 via the encoding operation module, i.e. the window encoding module 330, and transmits the encoded shared data to the remote host 200 through the transmission module 180.

Note that since the window picture is different from a normal picture file, the window encoding module 330 may utilize function libraries corresponding to the window screen within the computer operating system to compress and encode the preview screen corresponding to the shared document to at least one video stream, such as utilizing an encoding algorithm that is specially used for compressing texts and lines and corresponds to the window screen for the preview screen compression.

FIGS. 3A and 3B show schematic diagrams of functional blocks corresponding to a document sharing operation according to the invention, wherein FIG. 3A represents functional blocks used for performing the document sharing operation in the sharing host 100 while FIG. 3B represents corresponding functional blocks used in the remote host 200.

In this embodiment, the window selection module 340 is used for the user to select a shared document that is to be shared. When the shared document is a previewable document, the user may view the preview content of the selected document on the preview window without using any programs to open it first, thereby saving time needed to open the document. The preview module 310 may display the preview content of the previewable document on the presentation window provided by the user interface (UI) module 130 through the window screen capturing module 320 such that the user is capable of operating the preview content via the presentation window. When operating the preview content via the presentation window, the data sharing module 150 may store and update the updated screen corresponding to the preview content of the shared document to the remote host 200.

In some embodiments, some operating systems may already support a preview function for particular document file formats. In this case, the preview function can be activated to obtain the preview content. However, in some embodiments, the operating system or other document file formats may not support the preview function, and thus the opened content will be served as content of a normally opened window and processed as a window sharing operation.

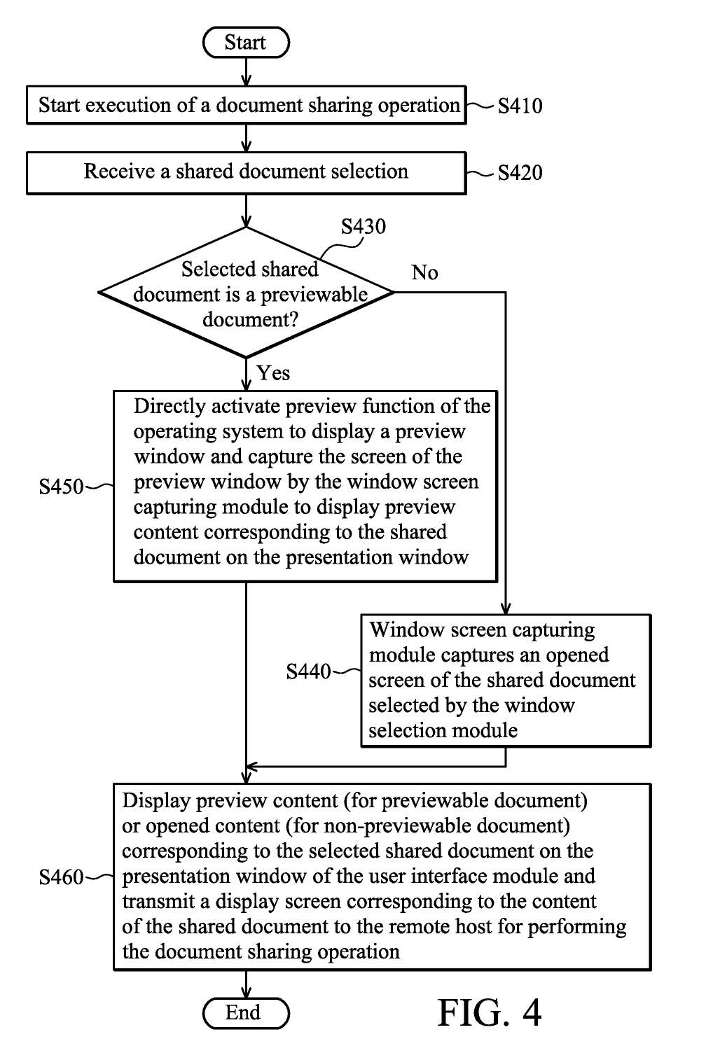

FIG. 4 is a flowchart showing an embodiment of a data sharing method for performing a document sharing operation in the sharing host 100 according to the invention. The data sharing method according to the invention may be applied in a data sharing system capable of providing an instant communication function such as computer systems, portable devices and so on. For example, the data sharing method of the invention may be performed by the processing unit 110 of the sharing host 100 in the data sharing system 10.

In this embodiment, it is assumed that the data sharing system has already established an instant communication (e.g. a video conference) with the remote host 200 via a network. When a document sharing operation is requested by the user, in step S410, the data sharing system starts the execution of the document sharing operation. Thereafter, in step S420, the data sharing system receives a shared document selection. Note that the shared document selected may be a previewable document or an non-previewable document. The user may input the selection of a shared document by the user interface provided by the user interface (UI) module 130. In step S430, it is then determined whether the selected shared document is a previewable document. If not (No in step S430), in step S440, the window screen capturing module 320 captures an opened screen of the shared document selected by the window selection module 340 and then step S460 is performed. Contrarily, if the selected shared document is a previewable document, in step S450, preview function of the operating system is directly activated to display a preview window and the screen of the preview window is captured by the window screen capturing module 320 to display preview content corresponding to the shared document on the presentation window.

Finally, in step S460, preview content (for previewable document) or opened content (for non-previewable document) corresponding to the selected shared document is displayed on the presentation window PW of the user interface (UI) module 130 and a display screen corresponding to the content of the shared document is transmitted to the remote host 200 for performing the document sharing operation. When the window screen capturing module 320 stores the screen of the document preview content or the opened document content as a picture and the display module 190 displays the window picture of the preview window on the presentation window which is served as a shared window in the shared host via the user interface (UI) module 130, the data sharing system simultaneously compresses the successively received window pictures to corresponding video streams via the window encoding module 330 and sends the compressed video streams to the transmission module 180. Thereafter, the transmission module 180 sends the video stream of the window screen to the remote host 200 via the network connection module 140.

Referring with FIG. 3B, in the remote host 200, the data receiving module 210 will successively transmit the received video stream to the window decoding module 230 for decoding and the window decoding module 230 decodes the video stream to obtain the window picture and then sends the decoded image data to the display module 240 shown in FIG. 3B. The display module 240 may request the user interface (UI) module 250 to display the received image on the presentation window which is served as a shared window in the remote host 200. By doing so, the remote host may update the screen of the shared document displayed simultaneously when the user in the shared host edits the content of the shared document.

In one embodiment, when the document sharing, picture sharing or window sharing operation is performed, the data sharing module 150 of the sharing host 100 may further encode the shared data based on a window resolution of the remote host 200 to transmit a shared data matched to the window resolution of the remote host 200 to the remote host 200.

When the type of the shared data is a shared window, the data sharing module 150 may be a window sharing unit.

The window sharing unit 154 further comprises a window screen capturing module 510 and a window encoding module 520. In this embodiment, the encoding operation module is set to be the window encoding module 520.

FIGS. 5A and 5B show schematic diagrams of functional blocks corresponding to a window sharing operation according to the invention, wherein FIG. 5A represents functional blocks used for performing the window sharing operation in the sharing host 100 and FIG. 5B represents corresponding functional blocks used in the remote host 200. Note that, in one embodiment, the window screen capturing module 320 and the window encoding module 330 may also be used as the window screen capturing module 510 and the window encoding module 520.

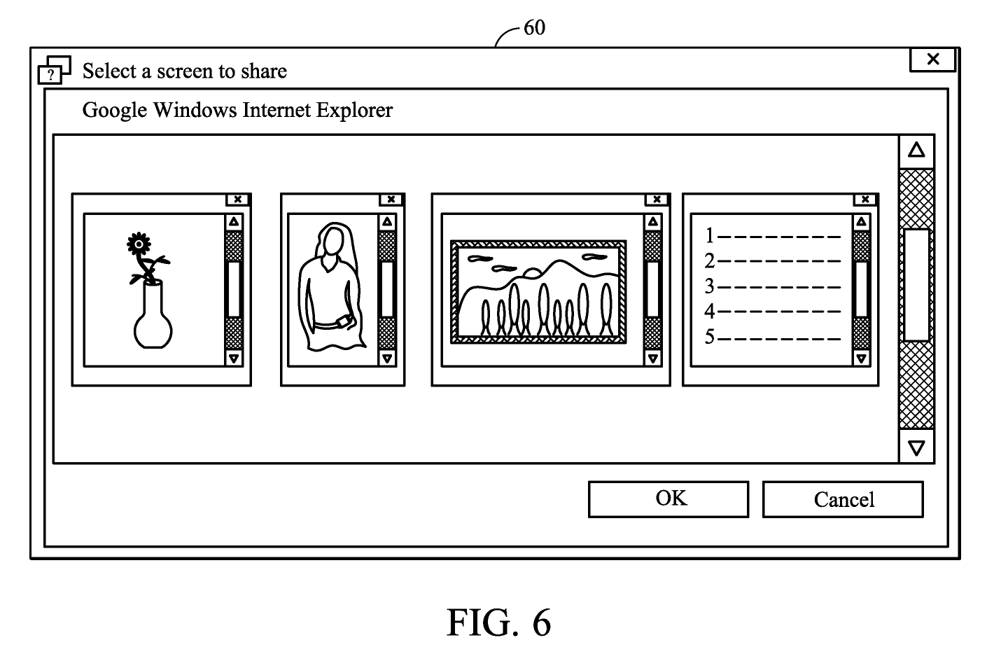

As shown in FIG. 5A, the window selection module 530 is used for the user to select a shared window that is to be shared, wherein a shared window is a window that is currently opening. To provide a clear shared window selection for the user, in this embodiment, a selection window is further provided, as shown in FIG. 6.

FIG. 6 shows a schematic diagram of an embodiment of a selection window 60 according to the invention. As shown in FIG. 6, the selection window 60 may display reduced screen picture of all windows that are currently opened and thus the user may simply click to the corresponding reduced screen picture to pick up a shared window. For each reduced screen picture, each reduced screen picture is a dynamic reduced screen picture that updates automatically according to the computer operation, that is, the dynamic reduced screen picture may vary dynamically along with the opened window and thus it is not just a still picture.

For example, in one embodiment, the dynamic reduced screen picture may be implemented by using DwmUpdateThumbnailProperties( )related APIs in a Microsoft Window Vista ™ operating system.

After the shared window has been selected by the window selection module 530, the window screen capturing module 510 will repeatedly store a handler screen to a corresponding picture and send a picture to the window encoding module 520 and the display module 190 each time the picture is obtained.

For example, for a Windows based operating system, content buffer of a target window may be retrieved to obtain screen data of the target window via a desktop window manager (DWM), and then the obtained screen data of the target window is stored as a picture, encoded and sent to the remote host.

Therefore, in one embodiment, whether the DWM is currently running is first determined and if so, the window sharing method of the invention may be performed.

The window encoding module 520 (similar to the window screen capturing module 320) compresses the successively received window pictures to corresponding video streams and sends the compressed video streams to the transmission module 180. Thereafter, the transmission module 180 sends the video stream of the window screen to the remote host 200 via the network connection module 140. As shown in FIG. 5A, the display module 190 will display the received window picture on the presentation window PW which is served as a shared window by the user interface (UI) module 130 each time one window picture has been received.

Referring with FIG. 5B, in the remote host 200, the data receiving module 210 will successively transmit the received video stream to the window decoding module 230 for decoding and the window decoding module 230 decodes the video stream to obtain the window picture and then sends the decoded image data to the display module 240 shown in FIG. 5B. The display module 240 may request the user interface (UI) module 250 to display the received image on the presentation window which is served as a shared window in the remote host 200. Similarly, by doing so, the remote host may update the screen of the shared window displayed simultaneously through the successively video streams received when the content of the shared document is repeatedly updated (e.g. the content of the opened webpage will be updated via the network).

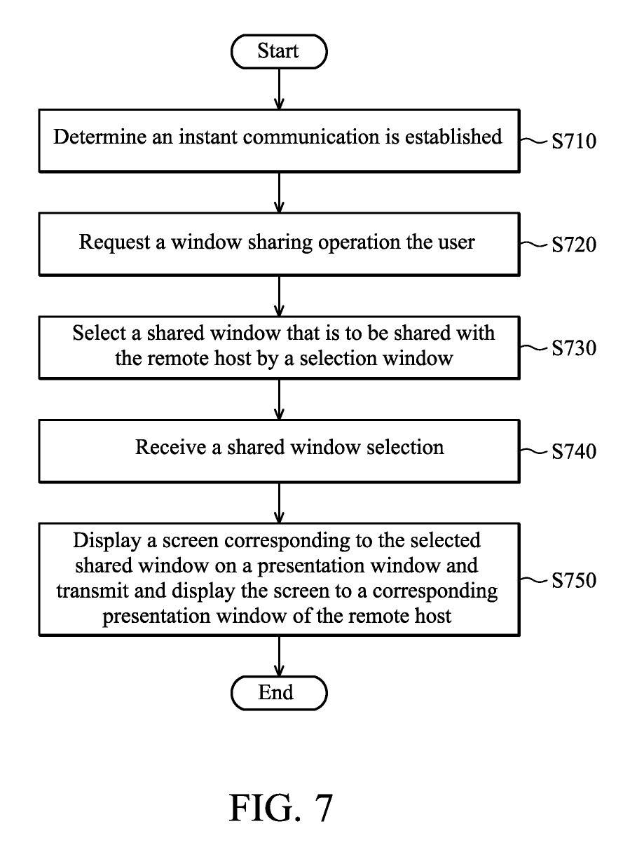

FIG. 7 is a flowchart showing an embodiment of a data sharing method for performing a window sharing operation in the sharing host 100 according to the invention. The data sharing method according to the invention may be applied in a data sharing system capable of providing an instant communication function such as computer systems, portable devices and so on.

As shown in FIG. 7, first, an instant communication is established has been determined (step S710). Thereafter, a window sharing operation is requested by the user (step S720). After receiving instructions for performing a window sharing operation, the user may input a selection of a shared window by a selection window (step S730), wherein the selection window comprises at least one reduced screen picture of a candidate window (e.g. the aforementioned dynamic reduced screen picture) and the candidate window is a window currently opened. Accordingly, a shared window selection is received (step S740). Finally, a screen corresponding to the selected shared window is displayed on a presentation window and this screen is further transmitted to the remote host 200 and displayed on a corresponding presentation window of the remote host 200 (step S750). In step S750, the window screen capturing module 510 stores the screen of the shared window as a picture and the display module 190 displays the window picture of the shared window on the presentation window which is served as a shared window in the sharing host 100 via the user interface (UI) module 130. The window encoding module 520 simultaneously compresses the successively received window pictures to corresponding video streams and sends the compressed video streams to the transmission module 180. Thereafter, the transmission module 180 sends the video stream of the window screen to the remote host 200 via the network connection module 140.

When the type of the shared data is a shared picture, the data sharing module 150 may be a picture sharing unit.

The picture sharing unit 156 further comprises a progressive image encoding module 810 for converting a shared picture file selected by the picture selection module 820 to a progressively compressed picture. In this embodiment, the encoding operation module is set to be the progressive image encoding module 810.

FIGS. 8A and 8B show schematic diagrams of functional blocks corresponding to a picture sharing operation according to the invention, wherein FIG. 8A represents functional blocks used for performing the window sharing operation in the sharing host 100 and FIG. 8B represents corresponding functional blocks used in the remote host 200.

In this embodiment, the picture selection module 820 is used for the user to select a shared picture file that is to be shared for performing a picture sharing operation. For example, the user may select a picture file such as a BMP file, PNG file or JPEG file via the user interface. The progressive image encoding module 810 converts the picture file selected by the picture selection module 820 to a progressively compressed image, i.e. an original picture file is compressed and divided into n data packets. When the remote host 200 receives a first data packet, the progressive image decoding module 220 is utilized to decode a blur image. The more the number of the data packets received close to n, the more the decoded image close to the IM service before compression. A complete original picture is obtained after all of the n data packets have been decoded. For example, the progressively compressed image may be implemented by using a Progressive JPEG compression.

The transmission module 180 then sequentially transmits the n data packets to the remote host 200 via the network connection module 140.

The display module 190 shown in FIG. 8A utilizes the user interface (UI) module 130 to display the picture file selected by the picture selection module 820 on the presentation window which is served as a shared window in the sharing host 100. In the remote host 200, the data receiving module 210 transmits a data packet to the progressive image decoding module 220 when it is received. The progressive image decoding module 220 then decodes the received data packet and obtains a clearer image by decoding based on the current and previously received data packets and transmits the decoded image to the display module 240 in FIG. 8B. The display module 240 requests the user interface (UI) module 250 to display the image on the presentation window which is used for picture sharing in the remote host. Since the picture is shared by a progressive image transmission way, the user in the remote host 200 may quickly obtain a rough image of the shared picture.

In summary, according to the data sharing method and related sharing system, the user may perform picture, window and document sharing operations while performing instant communications such as audio/video conferencing, thus providing a variety functions for the user. Additionally, the user may draw on the presentation window that is used for displaying the shared picture, window or document and view the drawing of the user in the remote host at the same time via the drawing module of the invention. Moreover, with the progressive picture sharing method of the invention, the remote user may quickly obtain a rough image of the shared picture to know the picture content without waiting for the completion of the file transmission for the whole shared picture. At the same time, with the document and window sharing operations of the invention along with the DWM provided by current operating system, the opened window may be shared and preview content of the previewable document may be obtained and shared via the preview function without utilizing any programs to open the document, providing fast data sharing and convenience in use.

Data sharing systems and sharing methods thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. An instant data sharing system, comprising:
a user interface (UI) module, operating the data sharing system by a user, wherein the UI module comprises a communication window and a presentation window;
an instant communication module, establishing an instant communication with at least one remote host via a network, wherein the user performs the instant communication with the remote host via the communication window; and
a data sharing module, selecting a shared data, displaying the shared data on the presentation window and transmitting the shared data to the remote host, wherein the data sharing module selects an encoding operation module to encode the shared data according to a type of the shared data, and transmit the encoded shared data to the remote host through a transmission module.

2. The instant data sharing system as claimed in claim 1, wherein the data sharing module further comprises a window selection module for providing the user with a window screen selection of an opened shared data.

3. The instant data sharing system as claimed in claim 2, wherein the type of the shared data is a shared window, the data sharing module is a window sharing unit and the encoding operation module is a window encoding module, and
wherein the window sharing unit further comprises a window screen capturing module for capturing a screen of a shared window selected by the window selection module for window sharing, and
wherein the data sharing module compresses and encodes the screen of the shared window captured by the window screen capturing module to a video stream and transmit the encoded video stream to the remote host through the transmission module.

4. The instant data sharing system as claimed in claim 3, wherein the selection module further comprises a selection window for displaying a reduced screen picture of at least one currently opened window.

5. The instant data sharing system as claimed in claim 4, wherein the reduced screen picture is a dynamic reduced screen picture that updates automatically according to the computer operation.

6. The instant data sharing system as claimed in claim 3, wherein encoding of the window encoding module utilizes function libraries corresponding to the window screen within the computer operating system.

7. The instant data sharing system as claimed in claim 2, wherein the type of the shared data is a shared document, and the data sharing module is a document sharing unit, comprising:
a preview module, generating a preview window to display preview content of the shared document; and
a window screen capturing module, wherein the window screen capturing module captures the screen of the preview window when the shared document is a previewable document while the window screen shared document that is selected by the window selection module when the shared document is not a previewable document,
wherein the data sharing module compresses and encodes the screen of the shared window captured by the window screen capturing module and transmit the encoded shared data to the remote host through the transmission module.

8. The instant data sharing system as claimed in claim 7, wherein the encoding operation module is a window encoding module and encoding of the window encoding module utilizes function libraries corresponding to the window screen within the computer operating system to compress and encode the preview screen corresponding to the shared document to a video stream and transmit the encoded video stream to the remote host through the transmission module.

9. The instant data sharing system as claimed in claim 7, wherein when the user performs an operation to the preview content via the preview window, the data sharing module further updates the screen corresponding to the shared document accordingly to the remote host.

10. The instant data sharing system as claimed in claim 1, wherein the type of the shared data is a shared picture, the data sharing module is a picture sharing unit and the encoding operation module is a progressive image encoding module, and
wherein the data sharing module further comprises a picture selection module for the user to select a shared picture file for picture sharing, and
wherein the progressive image encoding module converts a shared picture file selected by the picture selection module to a progressively compressed picture, wherein the progressively compressed picture has a plurality of data packets and the data packets are transmitted to the remote host in order via the transmission module.

11. The instant data sharing system as claimed in claim 1, wherein the data sharing module encodes the shared data based on a window resolution of the remote host to transmit a shared data matched to the window resolution of the remote host to the remote host.

12. The instant data sharing system as claimed in claim 1, further comprising a mouse event handling module for detecting and recording a moving track data of a mouse point on the presentation window, wherein the moving track data is transmitted to the remote host via the transmission module such that the remote host superimposes a drawing window that is generated to represent the moving track data according to the moving track data on the presentation window.

13. The instant data sharing system as claimed in claim 1, wherein the instant communication is a textural communication, a video conference communication, an audio communication and/or a combination thereof.

14. An instant data sharing system for establishing an instant communication between first and second hosts, wherein the first host further comprises:
a communication module, comprising:
a user interface (UI) module, operating the data sharing system by a user, wherein the UI module comprises a communication window and a presentation window;
an instant communication module, establishing the instant communication with the second host and displaying the instant communication content on the communication window; and
a data sharing module, selecting a shared data and performing an instant data sharing operation to the second host via the presentation window; and
a drawing module, having a mouse event handling module for detecting and recording a moving track data of a mouse point on the presentation window for the first or the second host, wherein the drawing module superimposes a drawing window that is generated for representing the moving track data according to the moving track data on the presentation window.

15. The instant data sharing system as claimed in claim 14, wherein the drawing module further configures the initial background color of the drawing window to a transparent color to display pictures representing the moving track data only when the drawing window is superimposed on the presentation window.

16. The instant data sharing system as claimed in claim 14, wherein the instant communication is a textural communication, a video conference communication, an audio communication and/or a combination thereof.

17. The instant data sharing system as claimed in claim 14, wherein the type of the shared data is a shared picture and the data sharing module is a picture sharing unit, wherein the picture sharing unit further comprises
a picture selection module for the user to select a shared picture file for picture sharing; and
a progressive image encoding module, converting a shared picture file selected by the picture selection module to a progressively compressed picture, wherein the progressively compressed picture has a plurality of data packets and the data packets are transmitted to the remote host in order via the transmission module.

18. The instant data sharing system as claimed in claim 14, wherein the second host further comprises:
a data receiving module, sequentially receiving the data packets corresponding to the progressively compressed picture from the first host; and
a progressive image decoding module coupled to the data receiving module, sequentially decoding each of the data packets corresponding to the progressively compressed picture to obtain a decode image that is an image which is firstly blurred and then becomes more and more clear.

19. A machine-readable storage medium storing a computer program, which, when executed, causes a device to perform a data sharing method, and the method comprising:
providing an operation interface for performing an instant communication and stabling an instant communication with a remote host via a network;
selecting a shared data;
capturing a screen of an opened window of the shared data according to a type of the shared data and displaying the captured screen on the operation selecting an encoding operation module to encode the shared data according to the type of the shared data and transmitting the encoded shared data to the remote host via a transmission module.
